(19) United States
(12) Patent Application Publication
(10) Pub. No.: US 2008/0142672 A1
(43) Pub. Date: Jun. 19, 2008

(54) Laptop Palm Support

(76) Inventor: Quang Tran, San Gabriel, CA (US)

Correspondence Address: Quang Tran, 438 W. Saxon Ave, San Gabriel, CA, 91776, US

(21) Appl. No.: 11/937,831

(22) Filed: Nov. 9, 2007

Related U.S. Application Data
(60) Provisional application No. 60/870,810, filed on Dec. 19, 2006.

(51) Int. Cl. B68G 5/02

(52) U.S. Cl. 248/560; 248/118

(57) ABSTRACT

The present invention provides a portable computer peripheral having an attachable palm rest to be integrated therein which allows the user to maintain a wrist-neutral position when using the portable computer. The portable computer palm rest comprises a computer friendly adhesive and color selective top layer for custom applications and a value-added method and apparatus that provides a safeguard by delivering an extra layer of comfort and protection between a User and his/her Laptop/Notebook/MacBook Computer.

This application emanates from a previously filed Provisional application number 60870810 filed Dec. 19, 2006

### FIELD OF THE INVENTION

The present invention is directed, in general, to portable computer peripherals, and more specifically to an attaching ergonomic palm rest for use with laptops.

The laptop palm support is a product/apparatus designed with You, Fun, Comfort and Your laptop/Notebook/MacBook Computer in mind. The premise for this invention addresses the matter related to bridging the adaptation gap between Man and Machine. This new and innovative invention provides a value-added conducive learning environment for Students, as well as an improved work setting for Employees through its functional faculties/use.

### BACKGROUND OF THE INVENTION

The use of and advantages associated with portable computers are well known in the art. Over the last decade, there has been an intense effort in the computer industry to down size the personal computer (“PC”) to provide users with a powerful yet portable computer that can be taken out of the office and fully utilized at home or on the road. As advancements have been made in both micro processing chip and battery technologies, particularly over the last decade, PCs were eventually downsized into “laptop computers”. While these computers offered the portability and processing power of a full sized PC, the laptop was still somewhat large and heavy for the user to carry around. In response to these disadvantages, the laptops were downsized even further into what is now commonly known in the industry as a notebook computer, which are smaller and lighter weight yet possessing equal or greater processing capabilities than their earlier laptop counterpart.

Because of their portability, notebook computers are frequently used in various places that require the user to operate the notebook computer from their lap, hence their name for their earlier counterpart. In such instances, the user must type with his or her wrists bent upwardly at an unnatural angle. This can lead to or exacerbate any pre-existing condition resulting from prolonged typing operations, such as tunnel carpel syndrome (“CTS”) or other typing-related injury that the user may have.

CTS have become a major problem with respect to individuals who do extensive amounts of typing during their typical work day. CTS are caused by cumulative damage to the finger tendons as they pass through a two to three centimeter (2-3 cm) long, narrow, rigid channel in the wrist, the carpal tunnel. With the hand oriented palm down, the roof of the carpal runnel is formed by the arch of the carpal bones and the floor by the tough transverse carpal ligament. The carpal tunnel contains the tendons for the fingers, the radial artery, and the median nerve which transmits sensation for the thumb and the first 2.5 fingers. Sensation for the remaining 1.5 digits is transmitted via the ulnar nerve which runs outside of the carpal tunnel.

As the hand deviates from normal either (i) horizontally either towards the thumb (radial deviation) or towards the little finger (ulnar deviation), or (ii) vertically up or down; the pressure on the carpal tunnel increases. Vertical deviations (extension/flexion) create significant increases in carpal tunnel pressure. Accelerations from extension to flexion are thought to pose the greatest risk for CTS, and when the hand is in a wrist neutral position (i.e., no vertical or horizontal deviation) then there is minimum pressure on the tendons and the median nerve in the carpal tunnel. With occupational overuse of the fingers, minor trauma to the tendons and the sheaths may accumulate and eventually produce CTS.

As the tendons or their sheaths become irritated and inflamed, the resulting swelling increases the pressure on the median nerve, which initially causes tingling, then numbness, and eventually disabling pain when the fingers are moved. Computer users are particularly at risk because of the large number of finger movements which the fingers may make in a short time. For example, a data entry worker who averages 13,000 key strokes per hour will make over half-a-million finger movements per week. In short, the three major risk factors for CTS are poor posture, pressure in the carpal tunnel and lack of pauses to allow time for tissue repair.

The use of QWERTY keyboard layouts, which can cause some ulnar deviation of both hands, and a positive keyboard angle which places the hands in an extended posture, combine to increase the risks of CTS. Over time these factors accelerate the accumulation of trauma to the hands/wrists, and this cumulative trauma is now appearing as the epidemic of CTS cases. Also, QWERTY keyboards usually are asymmetrical (i.e., the numeric keyboard is to the right of the QWERTY keys) and users tend to center the keyboard on their screen rather than centering QWERTY on the screen. This can result in users sitting in, twisted postures which increase the risks of back, shoulder and neck problems.

To reiterate, the major contributing factors to the occurrence of CTS are believed to fall primarily within the categories of (i) poor posture, (ii) no or insufficient pauses during work, and (iii) undesirable pressures. “Poor posture” includes (i) wrist extension, (ii) hand deviation, and (iii) poor seated posture. “No or insufficient pauses” include (i) repetitive movements. (ii) no or inadequate micro-breaks, and (iii) impaired tissue repair. “Undesirable pressures” include those pressures resultant from (i) flexion/extension accelerations, (ii) increased carpal tunnel pressure, and (iii) increased tissue trauma.

Because of the significance of the CTS problem, a number of previous products have attempted to reduce CTS risks. First, the layout of data entry keyboards have been modified. Keyboard re-designs to minimize horizontal radial or ulnar deviation have been developed. However, the problem of vertical deviation (extension) remains even with these keyboards. Also, postural risks from using other input devices (e.g., mouse) are obviously unaffected by modification to keyboard layout.

Second, wrist rests have been provided. Each arm weighs about 2.5% of a human's total body weight. The ability to rest the wrists on a support helps to reduce muscular activity in the forearm and incidentally reduce pressure in the carpal tunnel. However, problems of flexion/extension and ulnar/radial deviation remain because of the design and slope of the keyboard. Moreover, wrist rests defeat the portability aspect of notebook computers since the notebook computer is designed to be light-weight and as peripheral-component-free as possible.

Third, full motion fore-arm supports have been provided. These products provide full motion fore-arm support for the worker. Each arm is rested in a mobile support which takes the arm weight for all horizontal movements. However, as with wrist rests, problems of flexion/extension and ulnar/radial deviation remain because of the design and angle of the keyboard, and in a short-term test the use of full motion fore-arm supports resulted in a slight slowing of typing speed. Again, these devices are not well suited for portable applications because they affect the portability aspects of the computer.

Accordingly, there is a need in the art for a portable computer that has an ergonomically adjustable palm rest for attachment to the chassis of the portable computer to allow the user to achieve a wrist-neutral position (i.e. where the wrist is substantially supported) and thereby reduce the risk of CTS injury. In addition, the angle of the adjustable palm rest's orientation with respect to the plane of the keyboard can vary with different working environmental situations. The present invention provides a portable computer peripheral that addresses these needs.

### SUMMARY OF THE INVENTION

To address the above-discussed deficiencies of the prior art, the present invention provides an ergonomic laptop palm support to be attached to the open surface of a laptop. In a preferred embodiment, the palm rest attached to the structure of the portable computer's chassis. The palm rest is comprised of a palm support that has front and rear ends and with respect to the chassis between a covering position and an elevated first palm support position. Preferably, the palm support is adjustable about location which couples the palm support to the chassis. The palm rest further includes an adhesive back for attachment and removal.

This device is comprised of:
(1) Surface [top]
   Has a protective cushioned/padded/soft cloth-like surface area at the top that provides a physical and supportive separation layer between the User and his/her Laptop/Notebook Computer. This protective surface is referred to the laptop palm support top layer. The top layer can and will be offered in different cloth and/non-cloth-based materials.
(2) Base [bottom]
   Underneath the protective laptop palm support top layer lays another protective non-skid base made of a sponge-like rubber substance/material. This protective base is referred to the “Lap” or laptop palm support bottom surface layer. The bottom surface provides an added layer of padded comfort between the User and his/her Laptop/Notebook Computer. The bottom layer also serves a protective function to its Users.
(3) Form [shape]
   Each Laptop palm support produced is custom designed and manufactured to accommodate each User's requirements and/or specifications. The product irrespective of form/shape will function in its intended manner/method.

To use the Laptop palm support invention:
(1) User opens his/her Laptop Computer that he/she already owns.
(2) User removes the laptop palm support from its packaging if he/she has not already done so.
(3) User places the custom designed and manufactured Laptop palm support at the top surface of his/her Laptop Computer just underneath the Laptop Computer keys/keypads.
(4) The device is adjusted/re-adjusted accordingly by the User while on his/her Laptop Computer.
(5) User places his/her bottom palms/wrists on the apparatus and rests comfortably on the device surface.

Each support is custom designed and made. It can be constructed with round, straight/sharp finished corners/edges. It can also be constructed using different materials, produced in different colors, with or without a frontal flap that hangs over the base of the Laptop Computer. It can be constructed with or without additional devices used to secure the invention in place. The device can also be constructed to have the surface branded or personalized using custom graphical artwork, literary artwork and/or company logos.

Although the laptop palm support is designed to provide a User and his/her Laptop/Notebook/MacBook Computer a physical separation layer delivering a level of comfort between a User and his/her Laptop Computer, it can also be used as a moisture absorbent apparatus. Often resulting from prolonged hours of Laptop usage, the surface of the Laptop Computer where User's often rest their bottom palms/wrists areas begin to develop moisture and sweat. Laptop palm support's protective base can also be used to protect the bottom surface of a User's Laptop Computer from hard and scratch-prone surfaces. This invention can also be used as a functional complement to their computer mouse by providing a smooth surface. The Laptop palm support also serves to protect a User's Laptop/Notebook portable computer from potential scratches where User's commonly place and/or rest their bottom wrists/hands/palms on the top surface of their Laptop device located right below the keypads. With the Laptop palm support, there is also the inclusion of a cleanliness component/function that provides a system/utility that helps to keep the top surface of a Laptop computer where User's commonly place/rest their hands/wrists clean. Additionally, Laptop palm support also serves a protective function to its Users because often, differing and various models of Laptop computers have a tendency to become heated after prolonged hours of usage at the surface of the Laptop Computer.

In another aspect, the step of laptop palm support is a multi-layered, multi-colored adhesive support that is inexpensive to manufacture and attach.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a multiple mount, easily attachable laptop palm support for safe and comfortable laptop interaction.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

It is understood, of course, that while the forms of the invention herein shown and described include the best mode contemplated for carrying out the present invention, they are not intended to illustrate all possible forms thereof. It will also be understood that the words used are descriptive rather than limiting, and that various changes may be made without departing from the spirit or scope of the invention as claimed below.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a top frontal perspective view of the subject device both partially covering and totally covering the palm rest area of a laptop computer

FIG. 2 is a top frontal perspective view of the subject device while attached to a laptop computer.

### DETAILED DESCRIPTION OF THE DRAWINGS

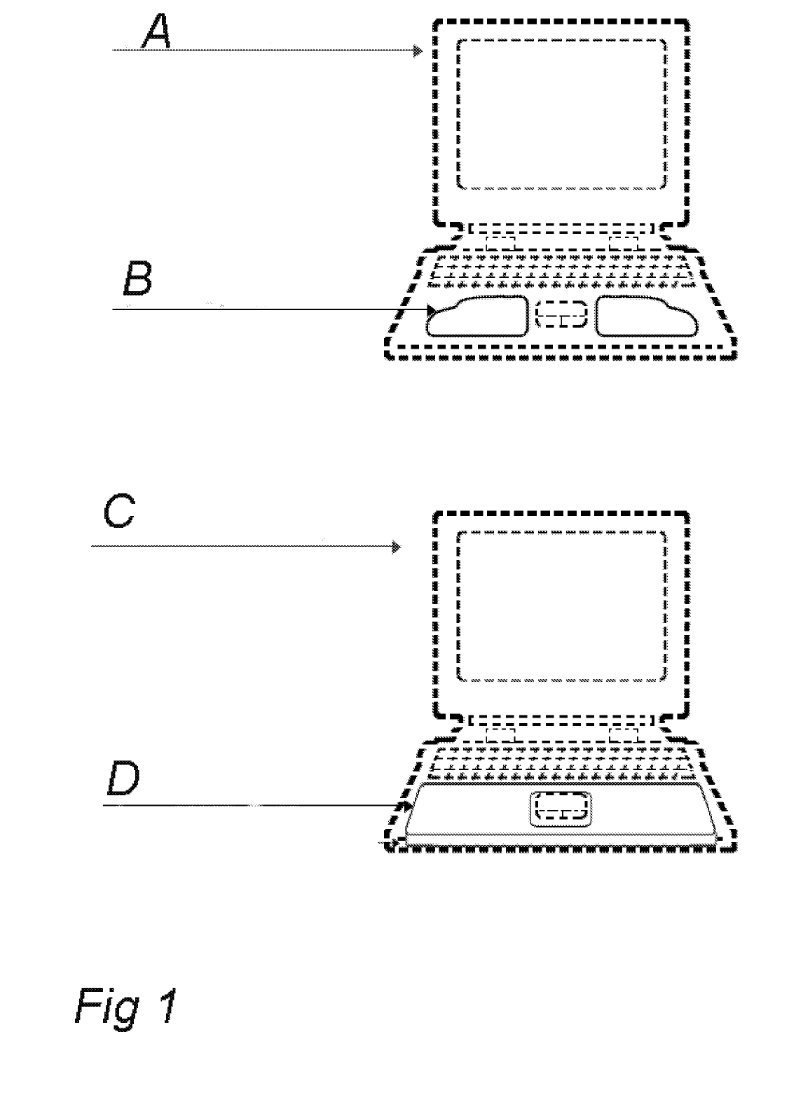

FIG. 1 depicts a typical shaped laptop computer A with the laptop palm support of the current device (B) attached to the palm rest area. FIG. 1, depicts (C) a laptop computer identified in broken lines with the laptop palm support (D) being completely covered by the laptop palm rest of the current invention.

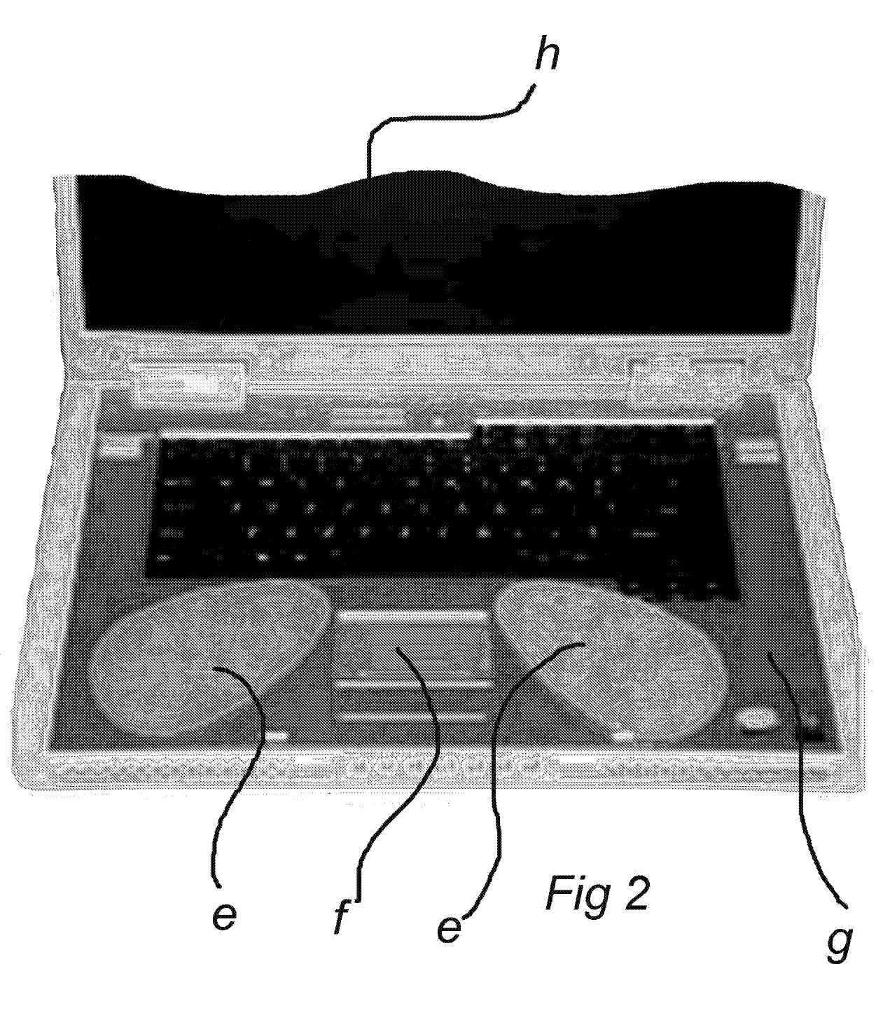

FIG. 2 depicts a laptop computer (h) in the open position with the current device (e) attached to both the right and left palm rest areas (g) of the laptop as situated left and right of the laptop touch pad (f).

As depicted in FIG. 2, the laptop palm support of the current device (e) can be easily attached through peel off adhesive to any palm rest area of the laptop (h). With as much ease, the current device can be removed and re-attached using said adhesive. The laptop support as depicted herein; shall embody adhesive, cushioning material and an array of decorative designs.

What is claimed is:

1. An ergonomically designed, self adhering laptop palm support with motion activated gel cushion.

2. The device of claim 1 wherein the surface of laptop palm support embodies a decorative finish.

3. The device of claim 1 wherein the laptop palm support embodies a kidney shape for ergonomic use.

4. The device of claim 1 wherein the adhesive of the laptop palm support is non-apparent after the removal of a peel off coating.

5. The device of claim 1 wherein the shape of laptop palm support will imitate and adapt to laptop surface.

6. The device of claim 1 wherein the cushion of the laptop palm support is dynamic.

7. The device of claim 1 wherein the cushion of the laptop palm support is attachable, detachable, movable and removable for use.

8. The component as claimed in claim 1 wherein the adhesive of the laptop palm support is polymer gel.

9. The component as claimed in claim 1 wherein the adhesive of the laptop palm support is shock absorbent.

10. The device of claim 1 wherein the thickness of the laptop palm support is cured to support 1/16″ (1.5875 mm); ⅛″ (3.1750 mm); ¼″ (6.35 mm); ½″ (12.70 mm).

11. The component as claimed in claim 3 wherein the composition of the laptop palm support is cured to form varying shapes conducive for ergonomic use.

12. The component as claimed in claim 1 wherein the adhesive layer disposed at one side of the laptop palm support layer, said adhesive layer is elastic.

13. The component as claimed in claim 4 wherein laptop palm support is non-apparent after peel-off is said cohesive non-sticky gel.

14. The device of claim 1 wherein laptop palm support is motion activated of said low resistance contact between a biological body and laptop palm support.

15. A palm support pad conformable to the surface of the human body and adapted to facilitate the transfer of hand movement-related signals between the body and motion-activated gel of claim 1 carried thereby, said gel impregnating and surfacing both sides of the laptop palm support.

16. A palm support pad having surface which comes into contact with fiber materials conformable to the surface of the human body of claim 1 carried thereby, said thread guiding component having a surface, wherein said surface contacts the fibrous materials providing improved ergonomic cushion between hands, laptop palm support cushion and laptop portable device.
